(19) United States
(12) Patent Application Publication
(10) Pub. No.: US 2009/0065435 A1
(43) Pub. Date: Mar. 12, 2009

(54) Modified Biogenic Silica and Method for Purifying a Liquid

(75) Inventors: Wenping Li, Pearland, TX (US); Carl E. Kiser, Lake Charles, LA (US)

Correspondence Address: PAUL S MADAN;MADAN, MOSSMAN & SRIRAM, PC, 2603 AUGUSTA DRIVE, SUITE 700, HOUSTON, TX, 77057-5662, US

(73) Assignee: Powell Intellectual Property Holdings, LLC, Baton Rouge, LA (US)

(21) Appl. No.: 12/206,162

(22) Filed: Sep. 8, 2008

Related U.S. Application Data
(60) Provisional application No. 60/971,027, filed on Sep. 10, 2007.

(51) Int. Cl. B01J 20/10; B01D 39/06; B01D 15/00

(52) U.S. Cl. 210/669; 210/660; 502/407; 502/408

(57) ABSTRACT

Biogenic silica is produced by combusting a biogenic source material such as rice hulls to give rich hull ash (RHA), and the combusted biogenic silica may be subsequently treated to improve the filtration or adsorption properties thereof e.g. by changing the surface charge, the surface tension, the surface area, the average pore size, the pore size distribution, particle size distribution, and/or the permeability thereof. Such biogenic silica is useful to remove a species, such as an impurity, from a fluid to purify the fluid and/or to recover the species therefrom. RHA may be used to remove species including organic, inorganic or microbial particulates, surfactants, metal ions, non-metallic anions, organic compounds, color bodies, odor-producing species, chlorinated compound, pigment, free fatty acids, phospholipids, peroxides, oil and/or grease different from the non-aqueous fluid, algae, bacteria, and combinations thereof.

### CROSS-REFERENCE TO RELATED APPLICATION

This application claims the benefit of U.S. Provisional Patent Application No. 60/971,027 filed Sep. 10, 2007.

### TECHNICAL FIELD

The present invention relates to methods for improving the filtration and/or adsorption of biogenic silica, the improved biogenic silica per se and methods removing a species from a fluid to purify the fluid using the biogenic silica, and more particularly relates, in one non-limiting embodiment, to methods for producing and modifying the filtration and/or adsorption properties of rice hull ash, the rice hull ash so improved, and methods of removing a species from a fluid using the improved rice hull ash.

### TECHNICAL BACKGROUND

Filtration and other separation methods are well known in general. The need to remove one or more species from a substrate or a fluid is often necessary to purify the species or the fluid, and/or to recover the species or the fluid which may be more valuable if separated. The term “filtration” has been generally used to indicate the removal of solids, although herein it is also defined to include the removal of one dissimilar liquid from another. Filtration can be described as the process of using a filter to mechanically separate a mixture of at least one solid and at least one fluid, or filtering out a first fluid from a second fluid by media rejection. Depending on the application, the solid, the fluid, or both may be isolated at some point. The term “separation” refers to removal of solids, or a dispersed, dissimilar phase from another phase either liquid or gas by other mechanism such as sedimentation, centrifugation, coalescing, squeezing, etc. Traditional filtration and separation refers to removal of a dispersed or discontinued phase from a continuous phase. Pretreatments such as coagulation and flocculation sometimes are necessary to enhance filtration and separation. However, if the species to be removed are dissolved or in a continuous phase, adsorption to physically or chemically remove the solubles are involved in filtration and separation process. “Adsorption” is defined herein as the adherence of atoms, ions or molecules of a gas or liquid to the surface of another substance, called the adsorbent.

It is common in many industries for there to be large quantities of liquids containing undesired species, e.g. suspended solid particles, metals, hazardous inorganic or organic compounds, such as liquid waste, which in the past have been discharged in the environment without filtration or separation. Current federal and state regulations limit the discharge of such liquids and liquid wastes into the environment.

Liquid filtration is normally involved in treatment of the liquid waste to meet environmental disposal regulations. Liquid filtration may be of two major classes: cake filtration and clarifying filtration. Cake filtration is used to separate slurries carrying relatively large amounts of solids. On the other hand, clarifying filtration is normally applied to liquid containing less than 1% solids. In cake filtration, solids are rejected by a filter media and are built up on the filter media as a visible, removable cake which is normally discharged as “dry” (i.e. as a moist mass), sometimes after being washed in the filter. Types of cake filters include pressure filters, continuous-vacuum filters and centrifugal filters. Efficiency of filtration can be evaluated by filtration rate, cake liquid content and filtrate quality to meet the disposal or reclamation specifications. For liquid waste containing only insoluble solids, filtration or filtration with assistance of filter aids are effective for impurities removal. Filter aids are applied to improve filtration rate, % solids removal, and reduce cake liquid content. For liquid waste which contains insoluble solids, such as ions, heavy metals, or soluble molecules, if chemical pretreatment is not applicable, adsorption is normally involved for the insoluble impurities removal. Adsorption can be applied as granular adsorbent bed, or adsorbent powder suspended with liquid to be treated. Normally, adsorption properties of the suspending powder is more effective than granular bed. However, adsorbent powder particles are normally fine and difficult to be filtered, especially after molecules or other soluable impurities are attached to their surface. Filter aids may be added to assist filtration of powdered adsorbent. However, addition of filter aid may decrease cycle rate due to quick cake build up in a filter chamber, as one cycle ends once the filter chamber is filled. Extra dosage of filter aid solids or higher amount of cake solids also leads to high disposal cost. Therefore, it is highly desired to develop a powder adsorbent product with high filtration performance.

U.S. Pat. No. 4,645,605 is directed to filtration of wastes to separate impurities from liquids or gases with porous silica ash, such as rice hull ash (RHA), which provides good filtration with high purification efficiency, high flow rate and dry solid cake in liquid applications. Indeed, rice hull ash is a biogenic silica that serves as a high performance, renewable filter aid for all types of solid-liquid separation applications. These filter aids are superior to traditional products and deliver extraordinary value in filtration and separation and sludge dewatering operations as well as high purity, high volume liquid treatment applications.

It would be desirable if methods were devised that could improve the ability of RHA and other biogenic silica to be useful as filter media and/or filter aids for suspended solids removal as well as adsorbent for dissolved solids and/or solute molecules removal.

There may be difficulties or concerns with disposing of the filter cake or the filter medium if the solids being removed by the filtration process are objectionable. Filter cake disposal options include composting, depositing in landfills, incineration, land application, sometimes as dry fertilizer. However, depending upon the filter cake contents, limitations may exist including environmental and economic constraints.

A number of filter media or filter aids have been proposed which when incinerated yield much less ash than the incineration of a conventional product. Filter cake refers to the accumulated solids or semi-solid material remaining after a filtration or separation process. Some of the filter media or filter aids also increase the heating value of the filter cake to a value greater than 5,000 Btu per pound of filter cake so that the filter cake can qualify as fuel for industrial boilers, furnaces and kilns under federal recycling regulations. These other proposed products, however, generally have poor filtration characteristics, are very expensive (1.5 to 2.0 times the cost of conventional filter aids) and yield filter cake which is lower in quality than those from conventional filter aids. Diatomaceous earth (DE) is often used in filters, but frequently large quantities are required and sometimes the DE will coat and blind with oil or other substances in the liquid. It would be highly desirable to provide a filter aid and/or filter medium which has very good filtration characteristics, good flow rates, which when incinerated produces a minimum amount of ash, raises the heating value of the filter cake to a value greater than 5,000 Btu per pound, and is low cost.

### BRIEF SUMMARY

There is provided, in one non-restrictive form, a method for removing a species from a fluid using biogenic silica to give a purified liquid. The biogenic silica is produced by combustion of a biogenic source and then chemically or physically treating the biogenic silica. Chemically treating the biogenic silica include, but not necessarily be limited to, contacting with an alkali, an oxidation agent, an acid, a dehydration agent, an enzyme, a microbial material, a salt solution, an anionic solution, and/or a cationic solution. Physical treatments include the biogenic silica by a process including, but not necessarily limited to, combining the biogenic silica with a material such as Ca(OH)₂, CaCl₂, CaCO₃, lime, soda ash, an electrolyte, a polyelectrolyte, a coagulant, calcium silicate, aluminum silicate, magnesium silicate, chabazite or clinoptilolite zeolite, expanded perlite, diatomaceous earth, cellulous, and/or kenaf fiber. Physical treatments also include contacting the biogenic silica with steam, nitrogen, and/or carbon dioxide, as well as washing the biogenic silica with a liquid such as water and/or an acid. The chemical and/or physical treatment improves the filtration and/or adsorption of the biogenic silica. The species removal method further involves contacting a fluid containing the species with the treated biogenic silica. The fluid may be an aqueous or a non-aqueous fluid. The species removed may be organic, inorganic or microbial particulates, surfactants, non-metallic anions, metallic ions, total suspended solids (TSS), total dissolved solids (TDS), color bodies, odor-producing species, chlorinated compound, pigment, free fatty acids, phospholipids, peroxides, oil and/or grease different from the non-aqueous fluid, algae, bacteria, and combinations thereof. The species is removed from the fluid by both filtration and adsorption. The fluid is recovered to greater purity.

Further there is provided in an alternative, non-restrictive version, a method for improving filtration or adsorption of biogenic silica which involves producing biogenic silica by combustion of a biogenic source. In one non-limiting embodiment this may be by burning rice hulls to give rice hull ash. The biogenic silica is further treated chemically and/or physically. Chemical treating the biogenic silica includes, but is not necessarily limited to contacting the silica with an alkali, an oxidation agent, an acid, a dehydration agent, an enzyme, a microbial material, an anionic solution, a cationic solution and mixtures thereof. Physically treating the biogenic silica may be by a process including, but not necessarily limited to, combining the biogenic silica with a material such as Ca(OH)₂, CaCl₂, CaCO₃, lime, soda ash, an electrolyte, a polyelectrolyte, a coagulant, calcium silicate, aluminum silicate, magnesium silicate, chabazite or clinoptilolite zeolite, expanded perlite, diatomaceous earth, cellulous, and/or kenaf fiber. Physical treatment may also include contacting the biogenic silica with steam, nitrogen, and/or carbon dioxide. Additional physical treatments include washing the biogenic silica with water and/or an acid. The treatment improves filtration or adsorption of the biogenic silica. There is additionally provided in another non-restrictive version a biogenic silica produced by the above process.

### BRIEF DESCRIPTION OF THE DRAWINGS

FIG. 1 is a photograph of two samples from Example 1 of car wash water before and after modified rice hull ash treatment demonstrating remarkable improvement in turbidity and color; and

FIG. 2 is a photograph of three samples from Example 3 showing untreated (left), first step treated (middle) and second step treated (right).

### DETAILED DESCRIPTION

Rice hulls, when burned in a controlled combustion process, create a unique amorphous silica material—Rice Hull Ash. The rice hull ash is porous, incompactible, and easy to be suspended and dispersed in gas or liquid phase, which quality makes it an excellent filter aid product. The rice hull ash (RHA) may possess approximately 40 m²/g surface area (determined by Brunauer-Emmett-Teller (BET) method) which makes it suitable for an adsorbent. With different chemical or physical modifications, adsorption, filtration, and other physical chemical properties of RHA may be enhanced for specific various applications. The enhanced or modified rice hull ash may be used as filter aids that remove metals from wastewater and sequester them into the solid phase. Enhanced RHA filter aids may contain high Btus and burn away to minimize ashing. Enhanced RHA filter aids may offer a single product solution to treatments involving coagulation/flocculation and filtration. In some situations RHA filter aids may minimize solids production and energy requirements.

The present invention is directed to a filter aid or filter medium and a method of filtering or separating with the filter medium or filter aid or separation aid which has good porosity, pore size sufficient to allow the desired material to pass through and prevent the undesirable material from passing through, does not readily compact, does not form a sticky mass, such as clay when wet, is dimensionally stable at the temperature and pressure range that the filtration and separation occurs. The filter aid or filter medium also possesses adsorption properties. In particular, the filter aid or filter medium operates by adsorption, as defined herein. In case of filtration, such treated filter medium or filter aid may form a filter cake containing the filtered out material which produces minimal ash when incinerated and/or increases the heating value of the filter cake so that it will qualify as a fuel under federal recycling regulations.

In one non-limiting embodiment, the filter medium or filter aid is a biogenic silica. In producing biogenic silica, a renewable source material such as plants having a highly porous silica structure are burned which contain a mini-mum of 15% silica by weight in its dry matter and in another non-restrictive version 20% or more. There are a limited number of such plants that contain these high quantities of silica. Such plants include, but are not limited to, the stalks, straw and hulls of rice, equisetum (horsetail weeds), certain bamboos and palm leaves, pollen, sugar canes and the like, all of which when burned leave a porous ash that is highly desirable as a filtration medium or aid. Biogenic silica in amorphous state and in substantially porous form can be obtained either by burning or decomposition of the renewable source materials noted above.

One particularly suitable biogenic silica is rice hull ash. Rice hulls are high in silica content, containing about 18 to 22% by weight or higher, with the ash having a porous skeletal silica structure with up to approximately 75 to 80% open or void spaces by volume. In addition, it has been a challenge for the rice industry to dispose of rice hulls. While a number and variety of uses for rice hulls or rice hull ash have been proposed and employed, large volumes of rice hulls are burned, and their ash is often disposed by the rice industry as a waste material at great expense.

In one non-limiting embodiment, commercially available rice hull ash may be prepared by burning rice hulls in a furnace. In the process, raw rice hulls are continually added to the top of the furnace and the ash is continuously removed from the bottom. Temperatures in the furnace may range from 1000° to about 2500° F. (about 538 to about 1400° C.), and the time factor for the ash in the furnace may range from about 2 seconds to about five minutes. Upon leaving the furnace, the ash is rapidly cooled to provide ease in handling. When treated by this method, silica remains in a relatively pure amorphous state rather than the crystalline forms known as tridymite or crystobalite. The significance of having the silica in an amorphous state is that the silica ash maintains a porous skeletal structure rather than migrating to form crystals, and the amorphous form of silica does not cause silicosis thus reducing cautionary handling procedures. Advantageously, rice hull ash may have a purity of about 70 to about 98 wt % silica, in one non-restrictive version. The burning of the rice hulls is time-temperature related, and burning of these hulls under other conditions can be done so long as the ash is in an amorphous state with a porous skeletal structure.

Biogenic silica devoid of fiber is fire-retardant, and is dimensionally stable at low and elevated temperatures, in one non-limiting embodiment up to about 400° C., thus rendering it useful at elevated temperatures without structural change.

On a commercial burning of rice hulls as an energy source, the resultant ash had the following range of values shown in Table I in its chemical analysis (by weight):

TABLE I

| | |
|---|---|
| Silica | 92% to 98% |
| Moisture | less than 1% to 3% |
| Carbon | 1.5% to 7.5% |

The remaining proportion consists of minor amounts of magnesium, barium, potassium, iron, aluminum, calcium, copper, nickel, sodium, and chloride. Using the treatment methods herein, the rice hull ash may achieve a purity of about 70 to about 98 silica wt %.

The carbon content of the biogenic silica may be in a dispersed state throughout the material. In some situations, carbon concentration is not desired for filtration, considering the lower density, smaller size and contamination of the filter aids. However, if the average size of the carbon particles is over about 20 microns, the carbon may be activated and may thus provide a benefit in certain situations. The carbon may be activated if the ash is treated with superheated steam under standard conditions. This treatment removes particles that clog the pores of the carbon thus enormously increasing the ability of the carbon to absorb gases. If desired, of course, the rice hull ash or other biogenic silica may be burned until all or nearly all of the carbon is removed. However, in some filtration processes, the presence of the carbon is advantageous.

The biogenic silica herein and the methods of producing it involve many treatments. As noted, the method for producing the biogenic silica always involves combusting a renewable, biogenic source material including, but not limited to, rice hulls. However, the biogenic source material may undergo a chemical treatment, a physical treatment or both, either prior to and/or after the source material is combusted. Unless otherwise noted in the specification and claims herein, the combustion of the biogenic source material may occur before or after the chemical and/or physical treatment. Suitably, in one non-limiting embodiment, the combustion occurs before the chemical and/or physical treatment.

Chemical treatments of the source material may include contact with chemical including, but not necessarily limited to, an oxidation agent, an acid, an alkali, a dehydration agent, an enzyme, and combinations thereof under certain temperature and time to produce the modified or enhanced biogenic silica. The chemical treatment of source material or the ash product for physical structure changes thereof may be accomplished by contacting the silica with an oxidation agent, an alkali, a dehydration agent, an enzyme, a microbial material, and combinations thereof, particularly under certain temperatures and time. A further type of change by chemical treatment of the source material or the resultant ash may include changes of surface chemistry of the silica which may be accomplished by contacting the silica with a chemical selected from the group consisting of an alkali, an oxidation agent, an anionic solution, a cationic solution and combinations thereof to selectively enhance adsorption or/and filtration and separation of different species.

Besides chemical treatments of the source material, the silica after combustion can be treated physically, chemically, biochemically or blended with other functional material to enhance filtration and/or adsorption properties. Physically treating the silica to change and improve the physical properties and structure may be accomplished by contacting the silica with a substance including, but not necessarily limited to, steam, N₂, CO₂, and combinations thereof, again, particularly under certain temperatures and time periods. Suitable physical treatment under steam or N₂ or CO₂ environment may carried out at a temperature from about ambient up to about 100° C., alternatively from about 100 to about 100° C., with a treatment time ranges from 10 minute to 12 hours. Physical treatments also include, but are not necessarily limited to, washing, such as with water and/or acids. Suitable acids include the oxidizing agents mentioned below. Other physical treatments expected to be useful include, but are not necessarily limited to, crushing or other grinding, classification, screening, dry particle agglomeration treatment, and combinations thereof. Particular particle size distributions may be produced to correspond to various filtrate quality requirements, where in general the finer the particle size distribution, the more precise or higher the fine particulates/molecular rejection efficiency. Suitable dry particle agglomeration treatments include, but are not necessarily limited to, surface charge neutralization, compaction, tumbling, thermal, fluidization, mixing with/without binding agents, which binding agents include but are not limited to sodium silicate, potassium silicate, silicate powder, calcium carbonate, calcium acetate, water, starch, lignin based binding agent, etc. Agglomeration equipment that may be used includes but is not limited to disc pelletizer, paddle mixer, drum granulator, pin mixer, rotary kiln, fluidized bed, etc.

Chemical or biochemical treatment of the biogenic silica is used to change a chemical property of the silica, such as the surface charge thereof and/or the surface tension thereof to enhance or improve the species removal when the biogenic silica is used as a filter medium or filter aid. Another chemical property that may be changed by treating the combusted silica is the surface silica bond, by which is meant the ability of the surface silicon atoms to bond with passing species. A different chemical property that may be changed by treating is the amorphous silica phase; amorphous silica has different phases with different structures and certain structures may enhance the surface area for species removal applications. Chemical treatment of the source material or the ash product may be also used to change the physical structure, which may include, but are not necessarily limited to, increases in the surface area, opening up of or otherwise controlling the pore structure, increasing the pore size distribution, increasing the permeability of the silica, and combinations thereof. Chemical treatment of the biogenic silica can be also applied to enhance ion exchange properties by altering the concentration of cationic ions or anionic anions on the biogenic surface. More specifically, chemical or biological treatments of the silica to change physical structure, surface properties or chemical properties include, but are not necessarily limited to, hydrochloric acid, sulfuric acid, phosphoric acid, nitric acid, citric acid (and possibly other organic acids), hypochlorite, and combinations thereof, as oxidizing agents. Useful alkalis for these treatments include, but are not necessarily limited to, KOH, NaOH, and combinations thereof. Further, specific examples of suitable dehydration agents that may be useful include, but are not necessarily limited to, microwave treatments, sulfuric acid and combinations thereof. Suitable microbial materials include, but are not necessarily limited to, any bacteria which consume carbon or silica. Chemicals that may be used to change ion exchange properties include, but are not limited to, NaCl, KCl, H₂SO₄, HCl, HNO₃, KOH, NaOH, and combinations thereof, as well as the acid and alkali materials described elsewhere herein.

Besides physical, chemical and biological treatments of the biogenic silica to alter physical, chemical and surface properties for a product with enhanced filtration and adsorption properties, treatments also include, but are not necessarily limited to, combining the biogenic silica with a material selected from the group consisting of Ca(OH)₂, CaCl₂, CaCO₃, lime, soda ash, an electrolyte, a polyelectrolyte, a coagulant, calcium silicate, aluminum silicate, magnesium silicate, chabazite zeolites, clinoptilolite zeolites, expanded perlite, diatomaceous earth, cellulous, kenaf fiber, ion oxides, enzymes, microbial material, and combinations thereof. Typically the combining involves intimate mixing into a homogeneous mixture, although other forms of contacting may be employed, in non-limiting examples compression or injection. Suitable enzymes include, but are not necessarily limited to, proteases, betaglucanases and arabinoxylanases, lipases and the like. Suitable microbial materials include, but are not necessarily limited to, aerobic, anaerobic and facultative type bacteria. Suitable anionic solutions include, but are not necessarily limited to, copolymers of acrylamide and acrylic acid, sodium acrylate or other anionic monomers. Suitable cationic solutions include, but are not necessarily limited to, aluminum hydrochloride, ferrous chloride, ferric chloride, ferrous sulfate, ferric sulfate, aluminum sulfate, copolymers of acrylamide with a cationic monomer, cationically modified acrylamide or a polyamine, polyethyleneamines and polyethylenimines, cationic starches, melamine/formaldehyde polymers, modified tannins and gums.

Suitable chemical treatment temperatures may range between about 10 and about 50° C., alternatively, from about 50° C. independently up to about 100° C. Suitable treatment times may range from about 5 minutes to about 1 hour, alternatively up to about 6 hours, independently up to about 24 hours, alternatively from about 1 hour up to about 6 hours, or up to about 24 hours or from 6 hours to about 24 hours.

Similar to surface tension, adsorption is a consequence of surface energy. In a bulk material, all the bonding requirements (whether ionic, covalent or metallic) of the constituent atoms of the material are filled by other atoms in the material. However, the atoms on the surface of the adsorbent are not wholly surrounded by other adsorbent atoms and therefore can attract adsorbates, that is, the species to be separated or filtered out. The exact nature of the bonding depends on the details of the species involved, but the adsorption process is generally classified as physisorption (characteristic of weak van der Waals forces) or chemisorption (characteristic of covalent bonding). Herein, the adsorption property is affected by surface charge, surface polarity, adsorbent-adsorbate bonding energy, pore size, pore volume, and surface area, and may be quantitatively measured by aqueous phase isotherm, gas phase isotherm, iodine number, pore size distribution, pore volume, BET surface area, etc.

Expected improvements in the biogenic silica from the above-noted chemical, biological, physical or blending treatments may include controlled particle size, increased permeability of the silica, increased surface area of the silica, a controlled or designed pore size of the silica, a customized surface charge, surface polarity, surface chemical bond, surface structure, and combinations thereof. The surface area, permeability, pore size, surface charge, surface polarity, surface chemical bond, surface structure, and combinations thereof may be controlled by different degrees of chemical, biological, physical, and blending treatments at different dosage, concentration, and types of chemicals, under different temperature, pressure, and contact or reaction time, for different filtration and adsorption requirements, in non-limiting cases at different temperatures, pressures, treatment rates and times, and combinations of these parameters. More specifically, the filtration or adsorption of the biogenic silica is improved by change including, but not necessarily limited to, one or more of the following:
increasing the surface charge thereof by at least about 50% or altering type of the surface charge corresponding to species to be removed;
increasing the surface ion exchange cations or anions by at least about 100%;
increasing the surface area by at least about 100%, for instance from an average of about 35 m²/g to an average of about 70 m²/g;
increasing total pore volume by at least about 50%;
decreasing less than 10 micron fines content by about 80%, that is, decreasing the amount of fines having a size of less than 10 microns by about 80%; and/or
increasing the permeability of the silica by at least about 300%.

Increasing the surface charge of the biogenic silica increases the ability of the silica to adsorb species thereon. Adjustments of pore size, surface charge, and polarity enhance selective adsorption. Increasing the total surface area and pore volume additionally increases the capacity of the biogenic silica to adsorb. Decreasing the amount of fines of sizes less than 10 microns and increasing the permeability of the silica increases the efficiencies of filtration operation in which adsorbent and adsorbates are removed.

In another non-limiting embodiment herein, the biogenic silica may be combined with a combustible material having an increased Btu value compared to the biogenic silica. Such combination with the biogenic silica may also have the advantage of the biogenic silica material being a filter aid that helps the combustible material from compacting or forming a sticky mass. In one non-restrictive embodiment, suitable combustible materials include, but are not limited to, rubber, cellulose, rice hulls, carbon (including activated carbon), oily solid waste and combinations thereof. In general, these combustible materials are in a particulate form when combined with the biogenic silica. The amount of such combustible material as compared to the biogenic silica present may range from about 1:10 to about 2:1, depending on Btu value and filterability of the combustible material. The ratio range of rubber to RHA may range from about 1:1 to about 1.5:1.

In general, the optimal size range of the combustible material particles, such as rubber, is from about 20 mesh to about 30 mesh for most refinery and biological waste applications because this range matches well to most refinery and biological waste filtration problems where the native solids range in size from 5 to 100 microns. For liquids or liquid wastes where the native solids range in size from 100 to 1000 microns, the combustible material particle size is most effective in the 6 to 10 mesh range. For liquids or liquid wastes with native solids in the 1 to 5 micron range, the size of the combustible particles is most effective in the 80 to 100 mesh. A general mesh size range of the combustible material particles is from about 5 to 325; however, the effective range of particle sizes is a function of the native solids in the filtration problem. By routine experimentation the appropriate mesh size of the combustible material particles and the amount of biogenic silica particles present, if any, can be determined for effective filtration based on the size of the solids in the liquid or liquid waste. However, combustible material particle sizes outside the foregoing ranges may be present but contribute little if any to filtration but do contribute to the Btu content of the resulting filter cake containing filtered solids.

In another non-limiting embodiment herein, the method herein involves combining the biogenic silica with materials that will help bind up and/or chemically fix the species being removed from the fluid to keep it from migrating undesirably after separation or removal. Suitable binding materials include, but are not necessarily limited to, a cementitious material, or a strong alkali (NaOH, KOH) with the existence of polyvalent metal ions (Ca²⁺). The amount of such binding material as compared to the biogenic silica present may range from about 10 ppm to about 50% depending on pH, types and concentration of contaminants, and property and functions of binding materials. Examples of suitable materials that will function as cementitious materials include, but are not limited to, such as Portland cement, pozzolonic silicates, clay, and the like whereas examples of suitable alkalis that will function as binding materials include, but are not limited to, KOH, NOH.

In another non-limiting embodiment herein, the method herein involves combining the biogenic silica with materials that will oxidize the species being removed and convert the species from hazardous to nonhazardous, and then removed by filtration and separation. Examples of suitable oxidization agents include, but are not limited to, sulfuric acid, nitric acid, hypochlorite, O₃, and the like.

In another non-limiting embodiment herein, the method herein involves combining the biogenic silica with materials that will convert a dissolved phase of a species to a non-dissolved phase, or change a species from a continuous phase to a discontinuous phase, or increase particle size for more efficient filtration and separation. Suitable such materials include, but are not limited to, electrolytes, polyelectrolytes, flocculants, acid, alkali, clays, or oxidizing agents, or an emulsion breaker. Examples of suitable electrolytes include, but are not limited to, FeCl₂, FeCl₃, Fe₂(SO₄)₃, FeSO₄, AlCl₃, Al₂(SO₄)₃, CaCl₂, Mg(OH)₂, Ca(OH)₂, CaCl₂, CaCO₃, lime whereas examples of suitable polyelectrolytes that will function as binding materials include, but are not limited to, cationic or anionic or neutral coagulants; suitable flocculants include, but are not necessarily limited to anionic or cationic or neutral flocculants; and suitable clays may include, but are not necessarily be limited to kaolin, bentonite, DE, and the like. Examples of suitable oxidization agents include, but are not limited to, sulfuric acid, nitric acid, hypochlorite, O₃, Examples of the suitable emulsion breaker include, but are not limited to oil in water or water in oil emulsion breakers.

In another non-limiting embodiment herein, the method herein involves combining the biogenic silica with materials that will reduce the inhalable silica amount for a safer and low dust working environments. Such dedusting materials to prevent airborne dusting include, but are not limited to CaCl₂, water droplets, and the like.

Turning now to the separation, filtration, adsorption or species removal method per se, the aqueous or non-aqueous fluids that may be treated with the methods and biogenic silicas herein may include, but not necessarily be limited to, waste waters, process waters, oil drilling produced water, drinking waters, boiler water, swimming pool waters, drilling fluids, cooling waters, cooking oils, fish oils, biodiesels, ethanol, motor oils, coolants, lubricants, juices, beverages, brewery fluids, sugar solutions, pharmaceutical fluids, biosludges, and combinations thereof. In general, these are examples of fluids that are desired to be purified or in some manner cleansed by having one or more species removed therefrom. Such fluids may be destined for a future different use, for instance to be eventually ingested or eaten, such as in the case of cooking oils, fish oils, juices, beverages, brewery fluids, sugar solutions, pharmaceutical fluids, and the like. Alternatively, the fluids could be recycled to the original use, application or process that transformed them into a condition that required the species separation in the first place, such as in the case of waste waters, process waters, drinking waters, swimming pool waters, drilling fluids, cooling waters, and the like.

The species to be removed from the liquids in the methods using the biogenic silica herein include, but are not necessarily limited to, organic, inorganic or microbial particulates, surfactants, metal ions, non-metallic anions, organic compounds, color bodies, odor-producing species, chlorinated compound, pigment, free fatty acids, phospholipids, peroxides, oil and/or grease different from the non-aqueous fluid, algae, bacteria, and combinations thereof. Some specific, but non-restrictive examples of species that may be removed by the methods and biogenic silica herein include metal ions are selected from the group consisting of Cr³⁺, Cr⁶⁺, Fe²⁺, Fe³⁺, Co²⁺, Cu²⁺, Ni²⁺, Zn²⁺, Pb²⁺, Hg²⁺, and combinations thereof; the non-metallic anions are selected from the group consisting of As⁵⁺, p⁵⁺, Se⁶⁺, and combinations thereof; the organic compounds are selected from the group consisting of dye molecules, phenol, and combinations thereof; and the odor-producing species is selected from the group consisting of ammonia; as well as combinations of all of these. It will be appreciated that certain of these species, such as some of the metal and non-metallic ions may have intrinsic valued and thus would be valuable to recover on their own along with the respective purified liquid.

Using the biogenic silica to remove or separate a species from a fluid will entail using one or more of various known or common operations and processes. Such processes and methods include, but are not limited to, mixing, adsorption, sedimentation, filtration, centrifugation, and combinations thereof. Normally, mixing, adsorption, and separation mechanics are used to separate the species from a fluid, as just mentioned. Sometimes, a pretreatment on the fluid is necessary to enhance the adsorption, filtration and separation operations.

When the process involves filtration, a number of common filtration devices may be used. Suitable devices include, but are not limited to, batch filter presses, automatic filter presses, rotary drum filters, belt filters, belt presses, leaf filters, DE (diatomaceous earth) filters, Nutsche-type filters, membrane filters and separators, cross-flow filters, gravity granular media filters, vacuum granular media filters, pressure granular filters, automatic continuously backwashable granular filters, cartridge filters, candle filters, wedgewire filters, geotubes, settlers, continuous or batch thickeners, centrifuges, and combinations thereof.

In cases where the device is a granular media filter, the filter may contain single or multiple layer particulate media and the biogenic silica is applied as a mixture with the particulate media, or as a precoat, and combinations thereof, for instance as a filter aid or filter media per se.

In cases where the device involves body feed, the body feed may be any of those commonly used or yet to be developed that could benefit from being combined with biogenic silica. Such filter media may include, but are not limited to, carbon (including activated carbon), ion-exchanged resins, magnesium silicate, clay, zeolite, and the like. The biogenic silica described herein may also be used together with other known filtration aids including, but not limited to, diatomaceous earth or kieselguhr, wood cellulose and other inert porous solids, and combinations thereof.

In cases where the device involves a filter media or a filter element, the filter or the filter element can be impregnated with the biogenic silica. The filter media or filter element may be pleated, or have some other design or configuration that improves or increases surface area. The filter element is sintered from the biogenic silica, in another non-limiting embodiment.

In some processes, it may be helpful to contain the biogenic silica in a permeable container, such as one made of cloth, paper or other cellulosic material, plastic or other polymer, or any other porous, mesh-like or net-like structure or material that physically confines or restrains the silica while permitting the fluid to flow through, intimately mix with, or otherwise contact the silica.

When the process involves sedimentation in a settling tank or thickener with mixer or fluid circulation, the modified or enhanced biogenic silica is added to the tank with mixer or circulation at a dosage from 1% to 5% to adsorb dissolved, difficult to be removed species, and to act as a settling aid to assist sedimentation efficiency.

In some cases, the above discussed filtration and separation with the biogenic silica is associated with a pretreatment of the fluid. The pretreatment includes but is not limited to pretreating the fluid by controlling temperature (increasing or decreasing), or pH, or chemicals to transform soluble or very finely dispersed, difficult to be adsorbed, or difficult to filter species to insoluble, or large dispersed, and easy to be adsorbed or easy to be filtered species. In one non-limiting embodiment, the pretreatment temperature may range from about 20° C. to about 150° C., alternatively from about 15° C., independently up to about 80° C. When the pretreatment involves pH adjustment, the pH may be adjusted from about 0 to about 12, alternatively from about 5, independently to about 10. The chemicals used to pretreat the biogenic silica may be any of those previously mentioned as suitable in a chemical and/or physical treatment of the biogenic silica, either before or after combustion of the biogenic source. The biogenic silica may be added to such treated fluids as an adsorbent and filter aids in filtration applications or as an adsorbent or sedimentation aid in sedimentation applications necessarily with a cationic or anionic coagulants or flocculants. Suitable cationic coagulants and or flocculants include, but are not necessarily limited to aluminum hydrochloride, ferrous chloride, ferric chloride, ferrous sulfate, ferric sulfate, aluminum sulfate, copolymers of acrylamide with a cationic monomer, cationically modified acrylamide or a polyamine, polyethylene-amines and polyethylenimines, cationic starches, melamine/formaldehyde polymers, modified tannins and gums. Suitable anionic coagulants include, but are not necessarily limited to, copolymers of acrylamide and acrylic acid, sodium acrylate or another anionic monomer.

It will be further appreciated that in any particular adsorption, separation or filtration method it is not necessary for any particular species to be entirely or completely removed from the liquid for the methods herein to be considered successful since complete, 100% removal is, in many instances, impossible or impractical within economic limits. While complete removal is certainly a useful goal, pragmatic limits may be less than 100%, for instance, up to about 98% removal, or alternatively up to about 95% removal.

The invention will now be illustrated further with respect to certain Examples which are intended to further illuminate the invention, but not to limit it in any way.

### EXAMPLES

### 1. Color and Odor Removal from WW (Wastewater) Water

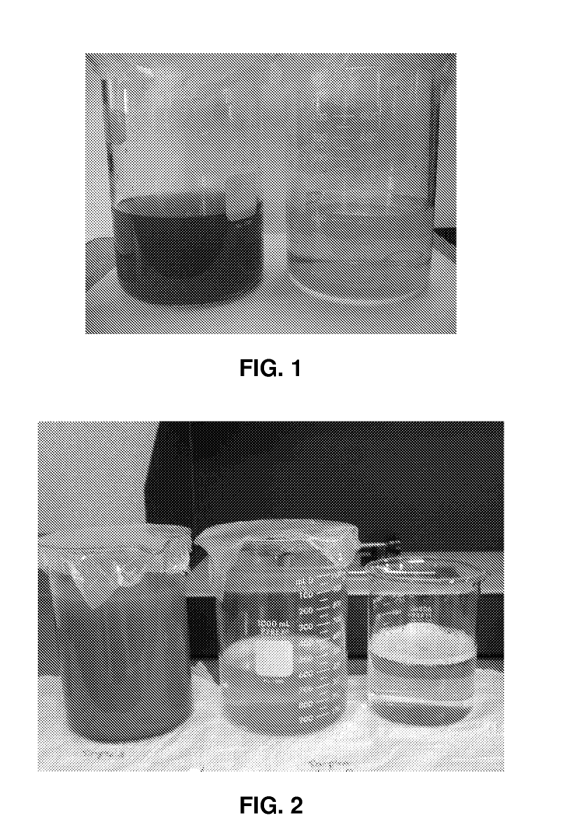

In this Example, the water to be treated is a car wash water with original turbidity 117 NTU, and over 500 PtCo color. After mixing with 5% modified rice hull ash (modified biogenic silica) for 10 minutes, and filtration with Whatman #2 filter paper, the turbidity of filtrate reduced to 10.7 NTU, and color was lowered to 131 PtCo. There was over 91% of turbidity and over 74% color removal. The original water had a strong NH₃ odor. The odor was greatly reduced after treatment. A picture of water before (left) and after (right) treatment is shown in FIG. 1. The rice hull ash was modified by alternating 10 minutes 20% H₂SO₄ wash and 10 minutes DI water rinse for three times. After the treatment, the BET surface area was increased from 35 m²/g to 65 m²/g (about doubled or an increase of about 100%). The increased BET surface area indicates increase of adsorption capability.

### 2. COD Removal from Water

This Example involved a wastewater stream which has a COD of 485 mg O₂/g, which is higher than regulated disposal limit. After filtration with addition of 2% cationic electrolyte treated rice hull ash, the COD was reduced to 71 mg O₂/g, which enabled disposal of the water stream. The cationic electrolyte was calcium chloride.

### 3. COD, BOD, and Oil and Grease(O&G) Removal

This Example involved a wastewater stream contained high COD, BOD and O&G content. The water was first mixed with a rice hull ash modified by a flocculant, and went through a filtration process. The filtrate was further mixed with a cationic electrolyte treated rice hull ash for 10 minutes, and went through a filtration process again. The COD, BOD, and O&G are reduced by 60%, 61%, and 100% respectively. Pictures of treated and untreated water sample are shown in FIG. 2, where on the left is the untreated water, in the middle is the first step treated water, and on the right was the second step treated water sample.

The flocculant was a cationic high molecular weight polyelectrolyte CETCO 2013 available from CETCO Oilfield Services Company. It was coated on the rice hull ash particles by mixing under ambient temperature and pressure. Dosages of the polyelectrolyte vary from 0.01% to 2%. The cationic electrolyte used in the further mixing was calcium chloride.

### 4. Sludge Dewatering

In this Example, dewatering of nine municipal waste water sludges was tested from January 2006 to March 2006. Sludge solid content ranged from 1.48 wt % to 2.61 wt %. Sludge was first treated by polymers at a dosage from 256 ppm to 264,000 ppm, and then mixed with 50% rice hull ash by weight of total sludge solid dosage. Test results on the nine samples consistently indicated that rice hull ash increased not only the sludge deliquoring rate, but also cake solid content, and filtrate quality. On one sludge sample, there were 37% increase of sludge dewatering rate, 33% decrease of cake thickness, and 41% decrease of cake water content. Filtrate color reduction of the sample with addition of RHA was 57.7%.

### 5. Green Algae Removal from Swimming Pool Water

This lab test involved filtration of swimming pool water by sand filters with a cationic coagulant-treated rice hull ash product as the sand bed precoat. The cationic coagulant was a positively charged electrolyte, particularly CaCl₂. The RHA particles were coated by the positively charged electrolyte by mixing under ambient temperature and pressure with dosage varying from 3-8% of a 20% solution. Comparison of filtration ending pressure and filtrate quality with the modified rice hull ash precoating, and with sand bed only are shown in Table II. Results show with the modified rice hull ash precoat, color, total suspended solids (TSS) and green algae removal efficiency of the sand filter are greatly improved. Precoating did not add too much extra operation pressure to the filter.

TABLE II
Example 5 Testing Data

| | | Turbidity | Color, | TSS, | Saturation | Green | Total | Ending |
|---|---|---|---|---|---|---|---|---|
| Sample # | pH | NTU | PtCo | mg/L | Index | Algae | Chlorine | pressure, psi |
| Ideal water | 7.4-7.6 | — | — | — | −0.3-0.3 | none | 1.5-3 | — |
| Untreated | 6.84 | 11.3 | 173 | 24 | −0.2 | extensive | 0 | — |
| Sand filter | 6.38 | 7.52 | 129 | 16 | −0.6 | extensive | | 0.6 |
| only | | | | | | | | |
| Modified rice | 7.12 | 3.37 | 59 | 8 | −0.2 | none | 0 | 9 |
| hull ash | | | | | | | | |
| precoating | | | | | | | | |
| filtration | | | | | | | | |
| % Removal | — | 67% | 66% | 67% | — | 100% | — | — |
| with modified | | | | | | | | |
| rice hull ash | | | | | | | | |
| precoating | | | | | | | | |

### 6. Heavy Metals Removal

This Example involved a plant scale wastewater treatment operation from a chemical plant with a treated RHA material for heavy metal removal and fixation. The RHA was treated by mixing under ambient conditions with Portland cement. After the modified RHA treatment, turbidity, TSS, copper, lead, zinc, nickel, chromium removal were all over 95%. The cake has passed the EPA TCLP test for safe disposal, which cannot be achieved without addition of the modified RHA product, thus demonstrating an improvement in both adsorption and filtration. The modified RHA with adsorption properties attach dissolved heavy metal iron to its surface. After filtration, the RHA and the cement material react to firm and fix the heavy metals

TABLE III
Example 6 Data

| | Untreated | Treated | | Discharge |
|---|---|---|---|---|
| Property | Water | Water | % removal | Limit |
| Turbidity, NTU | >100 | 0.06 | >99.4 | <0.2 |
| TSS, ppm | 100 | <0.2 | >99.8 | <1 |
| Copper, ppb | 2000 | <5 | >99.75 | 15 |
| Lead, ppb | 100 | <5 | >95% | 60 |
| Zinc, ppb | 3500 | <10 | >99.71 | 250 |
| Nickel, ppb | 400 | <5 | >98.75 | 130 |
| Chromium, ppb | 1000 | <100 | >90% | 150 |
| Capacity, gpd | 75,000 | 130,000 | | |
| Cake Pass TCLP | No | Yes | | Yes |

Gpd = gallons per day

### 7. Arsenic Removal

A chemical plant cooling water contained copper, sulfur, and arsenic and cannot be safely disposed. After filtration with 5% MAXFLO, the water quality was greatly improved. Testing results are shown in Table IV. Over 97% arsenic removal was shown in Table IV.

TABLE IV
Example 7 Data

| Property | Untreated Water | Treated Water | % removal |
|---|---|---|---|
| Copper, ppb | 44 | <2 | >95.5 |
| Sulfur ppm | 173 | <5 | >97.1 |
| Arsenic, ppb | 1000 | 30 | 97 |
| Iron, ppm | 1.1 | <0.072 | 93.5 |
| Lead, ppb | 50 | <5 | 90% |

### 8. Biodiesel Filtration and Soap, Water and Free Glycerine Removal

During biodiesel production processes, the final product needs to meet ASTM standard regarding water, free glycerine, and soap content. Current processes with a filter press and a filter powder suffer from filter media and filter cake blinding by precipitated soaps. In lab tests with a RHA as filter aids, the filtration rate increased 94%. The RHA had a controlled particle size produced by grinding and screening. There was also found to result 33% free glycerine removal, 100% soap and around 10% water reduction. Results with comparison of addition of the existing filter powder are shown in Table V.

TABLE V
Example 8 Data

| Type and Dose | Filtrate Rate, | Free Glycerine, | | Water, |
|---|---|---|---|---|
| of filter aids | gpm/ft² | mass % | Soap, ppm | ppm |
| original | | 0.012 | 477 | 523 |
| 1% current used | 0.84 | 0.003 | 0 | 562 |
| filter powder | | | | |
| 1% RHA | 2.76 | 0.008 | 0 | 474 |

### 9. Treatment with Acid Washed RHA

A chicken oil sample contained 2.95% Free Fatty Acid (FFA) was treated by 3% regular rice hull ash (RHA) and 3% acid washed rice hull ash, which has 40% more surface area than the regular rice hull ash. Removal of FFA by the regular RHA and acid washed RHA by adsorption is shown in Table VI. The results show 2.86 times higher FFA reduction by the acid washed RHA than by the regular RHA.

TABLE VI
Treatment with Acid Washed RHA

| Treatment | FFA removal % |
|---|---|
| With regular RHA | 2.86% |
| With acid washed RHA | 8.06% |

The acid wash procedure was as follows:
a) Mix 40 grams of ash in 200 grams of 50% H₂SO₄ with a magnetic stir for 2 hours and settle for 12 hours.
b) Decant the acid.
c) Add 400 grams of DI water, mix for 10 minutes with a magnetic stirrer and settle for 10 minutes, decant the washed water.
d) Repeat step c) for two more times.
e) Dewater the washed ash by vacuum filtration, and air dry the ash.

### 10. Treatment with Water Washed RHA

The washing agent can be deionized or demineralized water or acid water. An example of a final demineralized washed ash compared to unwashed water is shown in Table VII:

TABLE VII
Treatment with Water Washed RHA

| | Filter cake permeability, | Conductivity, |
|---|---|---|
| Samples | Darcy | μSiemens |
| Regular RHA | 0.2 | 1970 |
| Demineralized water | 0.8 | 508 |
| washed RHA | | |

The results of Example 10 show a substantial increase of filtration filter cake permeability which is an indication of filtration flow rate. Results also show 74.2% reduction of conductivity, which can be used as a measure of total dissolved impurities such as metals and chlorides.

In the foregoing specification, the invention has been described with reference to specific embodiments thereof, and is expected to be effective in providing methods and systems for separating and/or removing one or more species from liquids more efficiently. However, it will be evident that various modifications and changes can be made thereto without departing from the broader spirit or scope of the invention as set forth in the appended claims. Accordingly, the specification is to be regarded in an illustrative rather than a restrictive sense. For example, the chemical and/or physical treatments of the biogenic silica may be changed or optimized from those illustrated and described, and even though they were not specifically identified or tried in a particular method or application, would be anticipated to be within the scope of this invention. For instance, the use of different chemical agents other than the cementitious agents, oxidation agents, alkalis, dehydration agents, enzymes, microbial materials, anionic solutions, cationic solutions, specifically mentioned would be expected to find utility and be encompassed by the appended claims. Furthermore, different physical processes other than those specifically mentioned such as combustion, grinding, and the like may also be found to be useful. Different liquids and different species other than those described herein may nevertheless be treated and handled in other non-restrictive embodiments of the invention.

The present invention may suitably comprise, consist or consist essentially of the elements disclosed and may be practiced in the absence of an element not disclosed.

The words “comprising” and “comprises” as used throughout the claims is to interpreted “including but not limited to”.

What is claimed is:

1. A method for removing a species from a fluid to give a purified liquid comprising:
producing biogenic silica by combustion of a biogenic source;
treating the biogenic silica by a treatment selected from the group consisting of:
chemically treating the biogenic silica with a chemical selected from the group consisting of an alkali, an oxidation agent, an acid, a dehydration agent, an enzyme, a microbial material, a salt solution, and mixtures thereof;
physically treating the biogenic silica by a process selected from the group consisting of:
contacting the biogenic silica with steam, nitrogen, carbon dioxide and combinations thereof;
washing the biogenic silica with a liquid selected from the group consisting of water, an acid and mixtures thereof; and both;
size reduction by a method selected from the group consisting of crushing, grinding, classification, screening, dry particle agglomeration, and combinations thereof;
blending the biogenic silica with a material selected from the group consisting of a cementitious material, Ca(OH)₂, CaCl₂, CaCO₃, lime, soda ash, an electrolyte, a polyelectrolyte, a coagulant, a flocculant, calcium silicate, aluminum silicate, magnesium silicate, chabazite zeolites, clinoptilolite zeolites, expanded perlite, diatomaceous earth, cellulous, kenaf fiber, ion oxides, an enzyme, microbial material, and combinations thereof; and
combinations of chemically treating, physically treating and blending;
where the treatment improves filtration and/or adsorption by the biogenic silica,
contacting a fluid containing the species with the treated biogenic silica, where the species is selected from the group consisting of organic, inorganic or microbial particulates, surfactants, non-metallic anions, metallic ions, dissolved total suspended solids (TSS), total dissolved solids (TDS), color bodies, odor-producing species, chlorinated compound, pigment, free fatty acids, phospholipids, peroxides, oil and/or grease different from the non-aqueous fluid, algae, bacteria, and combinations thereof;
removing the species from the fluid by both filtration and adsorption; and
recovering the fluid to greater purity.

2. The method of claim 1 where the chemical treatment is conducted at a temperature between about 10 and about 100° C.

3. The method of claim 1 where the physical treatment of contacting the biogenic silica with steam, nitrogen, carbon dioxide and combinations thereof is conducted at a temperature from about ambient up to about 1000° C.

4. The method of claim 1 where the biogenic silica is rice hull ash.

5. The method of claim 4 where the rice hull ash has a purity of about 70 to about 98 silica wt %.

6. The method of claim 1 where the fluid is selected from the group consisting of drilling fluids, cooking oils, fish oils, biodiesels, ethanol, motor oils, coolants, lubricants, juices, beverages, brewery fluids, sugar solutions, pharmaceutical fluids, biosludges, and combinations thereof.

7. The method of claim 1 where the method at least partially occurs in a device selected from the group consisting of batch filter presses, automatic filter presses, rotary drum filters, belt filters, belt presses, leaf filters, diatomaceous earth filters, Nutsche-type filters, membrane filters and separators, cross-flow filters, gravity granular media filters, vacuum granular media filters, pressure granular media filters, automatic continuous backwashable granular media filters, cartridge filters, candle filters, wedgewire filters, geotubes, settlers, continuous or batch thickeners, centrifuges, and combinations thereof.

8. The method of claim 7 where the device is a granular media filter containing particulate media, and the biogenic silica is applied using a method comprising a step selected from the group consisting of:
applying the biogenic silica as a mixture with the particulate media (body feed),
applying the biogenic silica as a precoat, and
combinations thereof.

9. The method of claim 7 where the device contains a filter media or a filter element impregnated with the biogenic silica.

10. The method of claim 1 where the filtration and/or adsorption of the biogenic silica is improved by a change selected from the group consisting of:
increasing the surface charge thereof by at least about 50% or altering type of the surface charge corresponding to species to be removed;
increasing the surface area by at least about 100%;
increasing total pore volume by at least about 50%;
decreasing less than 10 micron fines content by about 80%;
increasing the permeability of the silica by at least about 300%; and/or
combinations thereof.

11. The method of claim 1 where the acid is selected from the group consisting of hydrochloric acid, sulfuric acid, phosphoric acid, nitric acid, and combinations thereof.

12. The method of claim 1 where the metal ions are selected from the group consisting of Cr³⁺, Cr⁶⁺, Fe²⁺, Fe³⁺, Co²⁺, Cu²⁺, Ni²⁺, Zn²⁺, Pb²⁺, Hg²⁺, and combinations thereof; the non-metallic anions are selected from the group consisting of As⁵⁺, p⁵⁺, Se⁶⁺, and combinations thereof; the organic compounds are selected from the group consisting of dye molecules, phenol, and combinations thereof; and the odor-producing species is selected from the group consisting of ammonia; and combinations of all of these.

13. The method of claim 1 further comprising pretreating the fluid by a process selected from the group consisting of increasing or decreasing the temperature thereof, increasing or decreasing the pH thereof, adding a chemical to affect the solubility of the species, increasing the size of the species, and combinations thereof.

14. A method for improving filtration or adsorption of biogenic silica comprising:
producing biogenic silica by combustion of a biogenic source; and
treating the biogenic silica by a treatment selected from the group consisting of:
chemically treating the biogenic silica with a chemical selected from the group consisting of an alkali, an oxidation agent, an acid, a dehydration agent, an enzyme, a microbial material, a salt solution, and mixtures thereof;
physically treating the biogenic silica by a process selected from the group consisting of:
contacting the biogenic silica with steam, nitrogen, carbon dioxide and combinations thereof;
washing the biogenic silica with a liquid selected from the group consisting of water, an acid and mixtures thereof; and both;
size reduction by a method selected from the group consisting of crushing, grinding, classification, screening, dry particle agglomeration, and combinations thereof.
blending the biogenic silica with a material selected from the group consisting of a cementitious material, Ca(OH)₂, CaCl₂, CaCO₃, lime, soda ash, an electrolyte, a polyelectrolyte, a coagulant, a flocculant, calcium silicate, aluminum silicate, magnesium silicate, chabazite zeolites, clinoptilolite zeolites, expanded perlite, diatomaceous earth, cellulous, kenaf fiber, ion oxides, an enzyme, microbial material, and combinations thereof; and
combinations of chemically treating, physically treating, and blending;
where the treatment improves filtration and/or adsorption by the biogenic silica,

15. The method of claim 14 where the chemical treatment is conducted at a temperature between about 10 and about 100° C.

16. The method of claim 14 where the physical treatment of contacting the biogenic silica with steam, nitrogen, carbon dioxide and combinations thereof is conducted at a temperature from about ambient to about 1000° C.

17. The method of claim 14 where the biogenic silica is rice hull ash.

18. The method of claim 17 where the rice hull ash has a purity of about 70 to about 98 silica wt %.

19. The method of claim 14 where the filtration and/or adsorption of the biogenic silica is improved by a change selected from the group consisting of:
increasing the surface charge thereof by at least about 50% or altering type of the surface charge corresponding to species to be removed;
increasing the surface area by at least about 100%;
increasing total pore volume by at least about 50%;
decreasing less than 10 micron fines content by about 80%;
increasing the permeability of the silica by at least about 300%; and/or combinations thereof.

20. The method of claim 14 where the acid is selected from the group consisting of hydrochloric acid, sulfuric acid, phosphoric acid, nitric acid, and combinations thereof.

21. Biogenic silica having improving filtration or adsorption prepared by the process comprising:
producing biogenic silica by combustion of a biogenic source; and
treating the biogenic silica by a treatment selected from the group consisting of:
chemically treating the biogenic silica with a chemical selected from the group consisting of an alkali, an oxidation agent, acid, a dehydration agent, an enzyme, a microbial material, a salt solution, and mixtures thereof;
physically treating the biogenic silica by a process selected from the group consisting of:
contacting the biogenic silica with steam, nitrogen, carbon dioxide and combinations thereof;
washing the biogenic silica with a liquid selected from the group consisting of water, an acid and mixtures thereof; and both;
size reduction by a method selected from the group consisting of crushing, grinding, classification, screening, dry particle agglomeration, and combinations thereof. P2 blending the biogenic silica with a material selected from the group consisting of a cementitious material, Ca(OH)₂, CaCl₂, CaCO₃, lime, soda ash, an electrolyte, a polyelectrolyte, a coagulant, a flocculant, calcium silicate, aluminum silicate, magnesium silicate, chabazite zeolites, clinoptilolite zeolites, expanded perlite, diatomaceous earth, cellulous, kenaf fiber, ion oxides, an enzyme, microbial material, and combinations thereof; and
combinations of chemically treating, physically treating and blending;
where the treatment improves filtration and/or adsorption by the biogenic silica,

22. The biogenic silica of claim 21 where the chemical treatment is conducted at a temperature between about 10 and about 1000° C.

23. The biogenic silica of claim 21 where the physical treatment of contacting the biogenic silica with steam, nitrogen, carbon dioxide and combinations thereof is conducted at a temperature from about ambient up to about 1000° C.

24. The biogenic silica of claim 21 of claim 14 where the biogenic source is rice hulls and the biogenic silica is rice hull ash.

25. The biogenic silica of claim 24 where the rice hull ash has a purity of about 70 to about 98 silica wt %.

26. The biogenic silica of claim 21 where the filtration and/or adsorption of the biogenic silica is improved by a change selected from the group consisting of:
increasing the surface charge thereof by at least about 50% or altering type of the surface charge corresponding to species to be removed;
increasing the surface area by at least about 100%;
increasing total pore volume by at least about 50%;
decreasing less than 10 micron fines content by about 80%;
increasing the permeability of the silica by at least about 300%; and/or combinations thereof.

27. The biogenic silica of claim 21 where the acid is selected from the group consisting of hydrochloric acid, sulfuric acid, phosphoric acid, nitric acid, and combinations thereof.
